(19) United States
(12) Patent Application Publication
(10) Pub. No.: US 2004/0157070 A1
(43) Pub. Date: Aug. 12, 2004

(54) Polyolefin tarpaulin coated with inorganic compound and manufacturing method thereof

(76) Inventor: Young-Sang Ki, Seoul (KR)

Correspondence Address: HAHN LOESER & PARKS, LLP, TWIN OAKS ESTATE, 1225 W. MARKET STREET, AKRON, OH, 44313, US

(21) Appl. No.: 10/391,344

(22) Filed: Mar. 18, 2003

(30) Foreign Application Priority Data
Feb. 11, 2003 (KR) 10-2003-8507

(51) Int. Cl. B32B 27/00

(52) U.S. Cl. 428/500; 428/515

(57) ABSTRACT

The present invention relates to a method for manufacturing polyolefin tarpaulin coated with inorganic compound comprising the steps of: producing the inorganic compound including several ingredients such as potassium 21.18 wt %, calcium 15.59 wt %, sodium 13.61 wt %, magnesium 13.31 wt %, iron 3.87 wt %, manganese 0.31 wt %, zinc 0.19 wt %, silicon 15.27 wt %, aluminum 13.75 wt %, others 1.92 wt %, mixing the inorganic compound with water and thereafter drying the mixed compound; forming a master batch by mixing the dried inorganic compound and resin for contacting; producing polyolefin tarpaulin through a coating device by mixing the processed master batch inorganic compound; providing a liquid type inorganic compound; and coating the produced polyolefin tarpaulin with the liquid type inorganic compound; the liquid type coating is performed on the surface layer of the processed polyolefin tarpaulin and then dried at the room temperature of 80-150 degree during 1-2 minutes. According to the polyolefin tarpaulin coated with inorganic compound of the present invention, there are several advantages that it is used to a general tent or a simple warehouse etc. and thus various functions such as antibiosis, keeping a thing warm and deodorization can be performed and also it may be used to a fish-farm for raising fries.

### BACKGROUND OF THE INVENTION

1. Field of the Invention

This application claims the benefit of Korean Patent Application Serial No. 10-2003-8507 filed Feb. 11, 2003. The present invention relates to a polyolefin tarpaulin coated with inorganic compound, more particularly to a polyolefin tarpaulin coated with inorganic compound and manufacturing method thereof, capable of performing various functions such as antibiosis, keeping a thing warm and deodorization.

2. Description of the Background Art

Generally, vinyl being used at a vinyl house for raising vegetable is made of polyethylene, which is processed into a thin film. Also, the vinyl transmits the whole wavelength region of the sunlight as it is.

Accordingly, in the conventional vinyl, there are disadvantages that since it transmits ultraviolet rays and X-rays etc., the growth of vegetable is interrupted and an oxidation action is prompted. So, a special measure to counter various fungi may be required.

Also, the vinyl made by the natural minerals such as silicate and the conventional synthesis minerals radiates only simple far-infrared rays and its effect is also insignificant.

Also, the polyolefin is a highly polymerized compound produced by the polymerization of olefin and includes polyethylene and polypropylene.

More specifically, among the polyethylene, a high density polyethylene (referred to HDPE) is used to a thread and a low density polyethylene (referred to LDPE) is used to coating. Also, the polypropylene includes polypropylene for the thread and coating.

### SUMMARY OF THE INVENTION

Accordingly, it is an object to provide a polyolefin tarpaulin coated with inorganic compound and manufacturing method thereof in which various functions such as antibiosis, keeping a thing warm and deodorization can be performed.

In order to achieve the above-described object of the invention, there is provided a method for manufacturing polyolefin tarpaulin coated with inorganic compound comprising the steps of: producing the inorganic compound including several ingredients such as potassium 21.18 wt %, calcium 15.59 wt %, sodium 13.61 wt %, magnesium 13.31 wt %, iron 3.87 wt %, manganese 0.31 wt %, zinc 0.19 wt %, silicon 15.27 wt %, aluminum 13.75 wt %, others 1.92 wt %, mixing the inorganic compound with water and thereafter drying the mixed compound; forming a master batch with a pellet shape by mixing the dried inorganic compound and resin for contacting; producing polyolefin tarpaulin through a coating device including a T-Die device by mixing the processed master batch inorganic compound at the condition of the ratio of polyethylene 30 wt %-95 wt % and the master batch 70 wt %-5 wt %; providing a liquid type inorganic compound; and coating the produced polyolefin tarpaulin with the liquid type inorganic compound; the liquid type coating is performed on the surface layer of the processed polyolefin tarpaulin and then dried at the room temperature of 80-150 degree during 1-2 minutes.

Preferably, in the mixing process of the dried inorganic compound and the resin for contacting, the polyolefin resin 95-30 wt % and the inorganic compound 5-70 wt % are mixed.

More preferably, the liquid type inorganic compound is processed by mixing the resin for contacting 10 wt %-20 wt %, the inorganic compound 10 wt %-20 wt %, organic solvent 70 wt %-60 wt %, and other addition material 10 wt %.

More preferably, the polyolefin woven cloth is weaved by the HDPE and LDPE and so it is constructed by two layers, such as the upper layer is formed by LDPE, the base layer is formed by HDPE.

More preferably, the polyolefin woven cloth is weaved by the HDPE and LDPE and so it is constructed by three layers, such as the upper layer is formed by LDPE, the middle layer is formed by HDPE and the base layer is formed by LDPE.

More preferably, the content of the inorganic compound coated to the tarpaulin is 3 wt %-15 wt %.

According to the another aspect of the present invention, there is provided to a polyolefin tarpaulin coated with inorganic compound comprising: inorganic compound in which various ingredients such as potassium 21.18 wt %, calcium 15.59 wt %, sodium 13.61 wt %, magnesium 13.31 wt %, iron 3.87 wt %, manganese 0.31 wt %, zinc 0.19 wt %, silicon 15.27 wt %, aluminum 13.75 wt %, others 1.92 wt % is included, the inorganic compound with water are mixed and thereafter dried the mixed compound; a master batch with a pellet shape in which the dried inorganic compound and resin for contacting is mixed; polyolefin tarpaulin produced through a coating device including a T-Die device in which the processed master batch inorganic compound with the ratio of polyethylene 30 wt %-95 wt % and the master batch 70 wt %-5 wt % is mixed; liquid type inorganic compound; and the produced polyolefin tarpaulin coated by the liquid type inorganic compound, wherein the liquid type coating is performed on the surface layer of the processed polyolefin tarpaulin and then dried at the room temperature of 80-150 degree during 1-2 minutes.

### BRIEF DESCRIPTION OF THE DRAWINGS

The present invention will become better understood with reference to the accompanying drawings which are given only by way of illustration and thus are not limitative of the present invention, wherein:

FIG. 1 is a flow chart illustrating manufacturing processes of the polyolefin tarpaulin coated the inorganic compound in accordance with an embodiment of the present invention; and

FIG. 2 is an outline perspective view illustrating a device for coating to the polyolefin woven cloth in accordance with the present invention.

### DETAILED DESCRIPTION OF THE PREFERRED EMBODIMENTS

A polyolefin tarpaulin coated the inorganic compound and manufacturing method thereof in accordance with preferred embodiments of the present invention will now be described in detail with reference to the accompanying drawings.

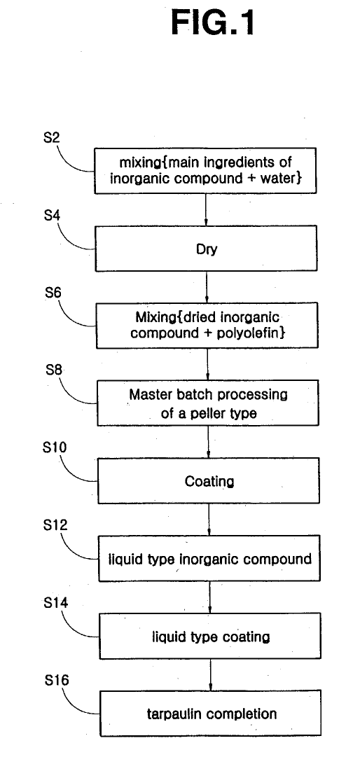

FIG. 1 is a flow chart illustrating the manufacturing processes of the polyolefin tarpaulin coated the inorganic compound in accordance with an embodiment of the present invention.

The inorganic compound being used in the present invention is made by using talc, silica, kaolin, feldspar, oxidized steel, sodium chloride etc. as main materials. Their ingredients are as follows: potassium 21.18 wt %, calcium 15.59 wt %, sodium 13.61 wt %, magnesium 13.31 wt %, iron 3.87 wt %, manganese 0.31 wt %, zinc 0.19 wt %, silicon 15.27 wt %, aluminum 13.75 wt %, others 1.92 wt %.

As mentioned above, in the method for manufacturing the polyolefin tarpaulin as shown in FIG. 1, firstly, the main ingredients of the inorganic compound is mixed with water in step S2. Thereafter, a dry process is performed in step S4. Thereafter, the dried inorganic compound and the polyethylene resin are mixed and at this time, the polyolefin resin 95-30 wt % and the inorganic compound 5-70 wt % are mixed in step S6. Thereafter, a master batch formation process of a pellet shape is performed through a mixing process in step S8.

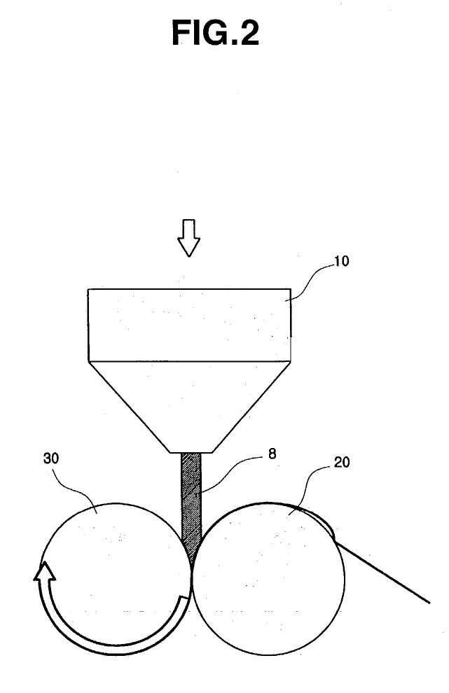

Thereafter, a coating process, in step S10, is performed at a coating device as shown in FIG. 2. The coating device is constructed by T-Die 10 positioned at the upper portion thereof and a pair of rollers positioned at the lower portion thereof. The T-Die 10 receives the polyolefin resin 8 provided from the upper portion to the lower portion and the coated polyethylene woven cloth with a predetermined length is wound through a rubber roller 20 and thus the polyolefin resin 8 is contacted on the polyethylene woven cloth and then coated on the polyethylene woven cloth through a roller 30, named an embo roller.

Thereafter, in step S12, the liquid type inorganic compound are also made and thereafter, in step S14, a liquid type coating is performed on the surface layer of the polyolefin tarpaulin processed through the steps S2-S10 on the polyolefin woven cloth with an amount of 25 g-200 g/m2 and then dried at the room temperature of 80-150 degree during 1-2 minutes.

Specifically, the polyolefin woven cloth is weaved by the HDPE and LDPE and so it is constructed by two layers, such as the upper layer is formed by LDPE, the base layer is formed by HDPE. Also, it may be constructed by three layers, such as the upper layer is formed by LDPE, the middle layer is formed by HDPE and the base layer is formed by LDPE.

In result, the coated polyolefin tarpaulin product with the content of the inorganic compound of 3-15 wt % is completed in step S16.

That is, the inorganic compound coating process is performed on the LDPE, not the HDPE and in the case that the coating is performed at the woven cloth having three layers, the coating may be performed at the uppermost surface layer and lowermost surface layer.

In reference, the polyolefin woven cloth, in special, the polyethylene woven cloth with a predetermined width is formed by crossing and weaving tape yarns made by using polyethylene resin as warp and weft.

Several tests are performed to the tarpaulin product. First, as an experiment of the radiation rate to far-infrared rays, the far-infrared rays radiation energy and the far-infrared rays radiation rate is 85% above in the wavelength 6-14 μm and is tested by the infrared rays spectrum photometer method.

Secondly, the antibiosis test is performed by the film contact method and the reduction rate of bacteria is 80-99.8% and the used fungi are 1-Escherichia coli atcc25922 and 2-Pesudomona aeruginosa ATCC 27853.

Thirdly, the deodorization test is performed by the gas detecting tube method with ammonia gas and so the initial deodorization rate is 14-90%, after 30-60 minutes, 20-90% and after 90 minutes, 30-90%.

As described above, in the tarpaulin product of the present invention, the ultraviolet rays are absorbed and stimulates various minerals included to the tarpaulin, so that the ultraviolet rays etc. are radiated from the inorganic compound contained to the tarpaulin.

This shows that the rays for giving harmfulness to the growth of vegetable are changed to the useful rays.

Specially, since the compound of the present invention includes a lot of amount of various ingredients such as potassium, calcium, sodium, magnesium, iron etc., which are similar to the ratio of inorganic ingredients of the vegetable, the internal sympathetic action (a resonance phenomenon) between the tarpaulin coated with the inorganic compound and the vegetable is induced, which do not exist in the conventional vinyl, so that the physiological activation of the vegetable is prompted and a great effect is exhibited.

As mentioned above, according to the polyolefin tarpaulin coated with inorganic compound and manufacturing method thereof of present invention, there are several advantages that it is used to a general tent or a simple warehouse etc. and thus various functions such as antibiosis, keeping a thing warm and deodorization can be performed and also it may be used to a fish-farm for raising fries.

Also, if the vinyl house made of the tarpaulin coated with the inorganic compound for raising vegetable is installed, since the tissue of vegetables become homogenous, the taste of vegetables is prompted like the natural state and also the volume of harvest is increased above 25%. Additionally, there is an effect that the vinyl protects vegetable from being damaged by cold-weather more or less.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds are therefore intended to be embraced by the appended claims.

What is claimed is:

1. A method for manufacturing polyolefin tarpaulin coated with inorganic compound comprising the steps of:
producing the inorganic compound including several ingredients such as potassium 21.18 wt %, calcium 15.59 wt %, sodium 13.61 wt %, magnesium 13.31 wt %, iron 3.87 wt %, manganese 0.31 wt %, zinc 0.19 wt %, silicon 15.27 wt %, aluminum 13.75 wt %, others 1.92 wt %, mixing the inorganic compound with water and thereafter drying the mixed compound;
forming a master batch with a pellet shape by mixing the dried inorganic compound and resin for contacting;
producing polyolefin tarpaulin through a coating device including a T-Die device by mixing the processed master batch inorganic compound at the condition of the ratio of polyethylene 30 wt %-95 wt % and the master batch 70 wt %-5 wt %;
providing a liquid type inorganic compound; and
coating the produced polyolefin tarpaulin with the liquid type inorganic compound; the liquid type coating is performed on the surface layer of the processed polyolefin tarpaulin and then dried at the room temperature of 80-150 degree during 1-2 minutes.

2. The method for manufacturing polyolefin tarpaulin according to claim 1, wherein in the mixing process of the dried inorganic compound and the resin for contacting, the polyolefin resin 95-30 wt % and the inorganic compound 5-70 wt % are mixed.

3. The method for manufacturing polyolefin tarpaulin according to claim 1, the liquid type inorganic compound is processed by mixing the resin for contacting 10 wt %-20 wt %, the inorganic compound 10 wt %-20 wt %, organic solvent 70 wt %-60 wt %, and other addition material 10 wt %.

4. The method for manufacturing polyolefin tarpaulin according to claim 1, wherein the polyolefin woven cloth is weaved by the HDPE and LDPE and so it is constructed by two layers, such as the upper layer is formed by LDPE, the base layer is formed by HDPE.

5. The method for manufacturing polyolefin tarpaulin according to claim 1, wherein the polyolefin woven cloth is weaved by the HDPE and LDPE and so it is constructed by three layers, such as the upper layer is formed by LDPE, the middle layer is formed by HDPE and the base layer is formed by LDPE.

6. The method for manufacturing polyolefin tarpaulin according to claim 1, wherein the content of the inorganic compound coated to the tarpaulin is 3 wt %-15 wt %.

7. A polyolefin tarpaulin coated with inorganic compound comprising:
inorganic compound in which various ingredients such as potassium 21.18 wt %, calcium 15.59 wt %, sodium 13.61 wt %, magnesium 13.31 wt %, iron 3.87 wt %, manganese 0.31 wt %, zinc 0.19 wt %, silicon 15.27 wt %, aluminum 13.75 wt %, others 1.92 wt % is included, the inorganic compound with water are mixed and thereafter dried the mixed compound;
a master batch with a pellet shape in which the dried inorganic compound and resin for contacting is mixed;
polyolefin tarpaulin produced through a coating device including a T-Die device in which the processed master batch inorganic compound with the ratio of polyethylene 30 wt %-95 wt % and the master batch 70 wt %-5 wt % is mixed;
liquid type inorganic compound; and
the produced polyolefin tarpaulin coated by the liquid type inorganic compound,
wherein the liquid type coating is performed on the surface layer of the processed polyolefin tarpaulin and then dried at the room temperature of 80-150 degree during 1-2 minutes.
